(19) United States
(12) Patent Application Publication
(10) Pub. No.: US 2013/0068832 A1
(43) Pub. Date: Mar. 21, 2013

(54) METHOD FOR WIRELESSLY CONTROLLING ELECTRONIC DEVICE WITH QUICK RESPONSE CODE AND ELECTRONIC DEVICE PRODUCT UTILIZING THE SAME

(71) Applicants: YI-CHI LI, NEW TAIPEI CITY (TW); TSUNG-TAO WU, NEW TAIPEI CITY (TW)

(72) Inventors: YI-CHI LI, NEW TAIPEI CITY (TW); TSUNG-TAO WU, NEW TAIPEI CITY (TW)

(73) Assignee: LIGITEK ELECTRONICS CO., LTD., NEW TAIPEI CITY (TW)

(21) Appl. No.: 13/238,078

(22) Filed: Sep. 21, 2011

(51) Int. Cl. G06F 17/00

(52) U.S. Cl. 235/375

(57) ABSTRACT

This prevention provides a method for wirelessly controlling an electronic device with a quick response code. The method is performed in a calculating device with internet capability. The method comprises receiving a graphics information of the quick response code of the electronic device, decoding the quick response code, downloading a controlling and driving program of the corresponding electronic device for installation according to the decoded quick response code, configuring an internet protocol of the electronic device by the controlling and driving program, and controlling the electronic device by the controlling and driving program through the internet protocol wirelessly. Accordingly, the calculating device with internet capability can control the electronic device with a quick response code, such that the calculating device with internet capability can improve living facilities of the user.

### BACKGROUND OF THE INVENTION

1. Field of the Invention

The present invention relates to a method for wirelessly controlling an electronic device; in particular, to a method for wirelessly controlling an electronic device with a quick response code and an electronic device product utilizing the same.

2. Description of Related Art

The daily used lighting device and home appliance usually function differently with some of them equipped with remote controllers for facilitating the remote control. For example, home appliance such as a television, a stereo set, or an air conditioner may have corresponding remote controller. However, the home appliance is not always cooperated with a remote controller. Most of the lighting device may not be controlled by a remote controller, and the home appliance with different manufacturer may not be integrated for controlling by a single remote controller.

On the other hand, the efficacy of the smart phone is improved because of the progress of the semiconductor technology. The smart phone may control an electronic device with wireless receiving capability through its' micro processor cooperated with a program such as, controlling the sound volume of a stereo set by the smart phone. The frequently used electronic devices are home appliances and lighting devices. And, the specification of the home appliances and lighting devices made by different manufacturers are not the same. Thus, it may be difficult to control the home appliances and lighting devices by a single remote controller. Therefore, using the smart phone to integrate the controlling of electronic devices is one of the goals of manufacturers.

In addition, the popular smart phone has photography functions, and a pattern so called the Quick Response Code (QR Code) is widely used in commercial. The human operator can capture the image of the quick response code through the photography function of the smart phone, and identify the contents of the quick response code by the program cooperated with the micro processor of the smart phone for obtaining the information carried by the quick response code, and then the human operator may obtain the information carried by the quick response code immediately. However, applications of the popular quick response code may be restricted to information disclosure, and the use of the quick response code is still limited.

### SUMMARY OF THE INVENTION

The object of the present invention is to provide a method for wirelessly controlling electronic device with a quick response code and electronic device product thereof.

In order to achieve the aforementioned objects, according to an embodiment of the present invention, a method for wirelessly controlling an electronic device with a quick response code is provided. The method is performed in a calculating device with internet capability. The method comprises receiving a graphics information of the quick response code of the electronic device, decoding the quick response code, downloading a controlling and driving program of the corresponding electronic device for installation according to the decoded quick response code, configuring an internet protocol of the electronic device by the controlling and driving program, and controlling the electronic device by the controlling and driving program through the internet protocol wirelessly.

In order to achieve the aforementioned objects, according to an embodiment of the present invention, an electronic device product is provided. The electronic device product comprises a quick response code and an electronic device. The quick response code is for providing a download address of a controlling and driving program of an electronic device. The quick response code is captured by an image capturing unit of a calculating device with internet capability, and the quick response code is decoded allowing for of the calculating device with internet capability to retrieve the controlling and driving program of the electronic device from the download address before having the controlling and driving program of the electronic device installed therein, for facilitating a wireless control over the electronic device by the calculating device with internet capability on basis of a control signal. The electronic device is used for receiving the control signal of the calculating device with internet capability.

In summary, the method for wirelessly controlling an electronic device with a quick response code and an electronic device product using the same utilize the calculating device with internet capability to capture the quick response code of the electronic device product and connect to the internet for downloading the control information in corresponds with the electronic device to the calculating device with internet capability. Accordingly, the human operation can control the electronic device by the calculating device with internet capability for making good use of the calculating device with internet capability and improving the life convenience.

In order to further the understanding regarding the present invention, the following embodiments are provided along with illustrations to facilitate the disclosure of the present invention.

### BRIEF DESCRIPTION OF THE DRAWINGS

FIG. 1 shows a flow diagram of a method for wirelessly controlling a lighting device with a quick response code according to an embodiment of the present invention;

FIG. 2 shows a schematic diagram of a link relation of lighting devices with quick response codes and a smart phone according to an embodiment of the present invention;

FIG. 3 shows a schematic diagram of a link relation of lighting devices with quick response codes and a smart phone according to an embodiment of the present invention;

FIG. 4 shows a schematic diagram of the lighting devices with the quick response codes controlled by a smart phone according to an embodiment of the present invention;

FIG. 5 shows a schematic diagram of an operation interface of a smart phone controlling the brightness of the lighting devices with the quick response codes according to an embodiment of the present invention.

### DETAILED DESCRIPTION OF THE PREFERRED EMBODIMENTS

The aforementioned illustrations and following detailed descriptions are exemplary for the purpose of further explaining the scope of the present invention. Other objectives and advantages related to the present invention will be illustrated in the subsequent descriptions and appended drawings.

[An embodiment of a method for wirelessly controlling a electronic device with a quick response code]

In embodiments presented in the follows, a lighting device is used as an example of an electronic device for the illustration of a method for wirelessly controlling the electronic device with a quick response code; however, the present invention is not restricted as the result. For example, the electronic device may be a home appliance in other examples.

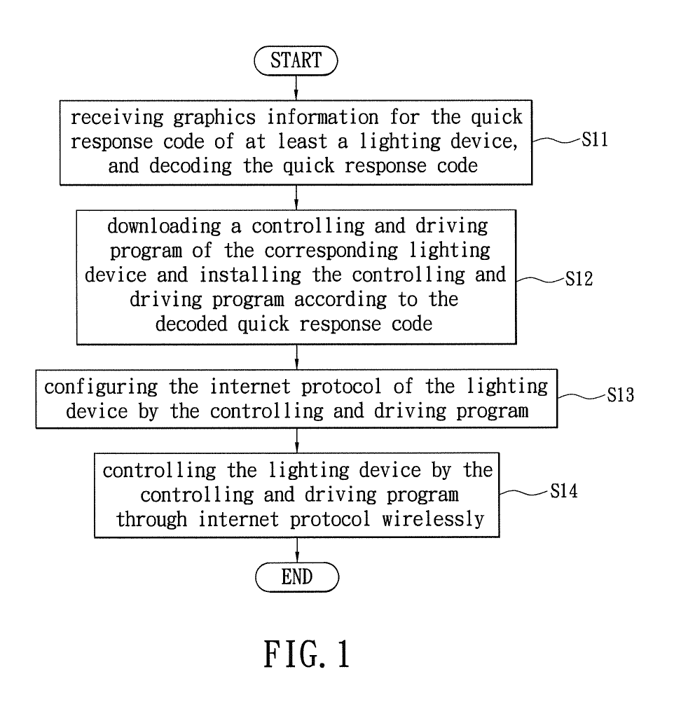

Please refer to FIG. 1, FIG. 1 shows a flow diagram of a method for wirelessly controlling a lighting device a with quick response code according to an embodiment of the present invention. The method for wirelessly controlling electronic device with a quick response code is performed in a calculating device with internet capability. The calculating device may be a handheld device such as a smart phone or a tablet PC. In addition, the quick response code may be printed on or adhered to a package, a user manual, or the electronic device, but the present invention is not so restricted.

The method comprises following steps and is described as follows. First, in the step S11, the disclosed method includes receiving graphics information of the quick response code of the lighting device, and decoding the quick response code. Then, in the step S12, the method further including downloading a controlling and driving program of the corresponding lighting device and installing the same according to the decoded quick response code. Then, in the step S13, the method includes configuring an internet protocol of the lighting device by the controlling and driving program. Then, in the step S14, the method further includes controlling the lighting device by the controlling and driving program through the internet protocol wirelessly.

It is worth noting that the steps S11˜S14 may be accomplished by a software (or program) installed in the calculating device with internet capability, because that the calculating device with internet capability may be a platform for the execution of application programs including the controlling and driving program. The software (or program) may includes functions of controlling the digital camera of the calculating device with internet capability, causing the controlling and driving program to be installed, and positioning and controlling the lighting device. In addition, the software (or program) may include an operation interface displayed on the screen of the calculating device with internet capability.

In the step S11 in which the graphics information of the lighting device is accomplished may be implemented by a digital camera of the calculating device with internet capability. The lighting device may be a lighting device having a light-emitting diode (LED)-based light source.

Besides, the digital camera of the calculating device with internet capability may be an imaging sensing device which is made of the charge coupled device (CCD) or the complementary metal-oxide-semiconductor (CMOS). However, the type of the digital camera of the present invention is not so restricted. In other words, the digital camera may be any types of the image capturing unit.

The calculating device with internet capability may decode the captured image file (as one example of the graphics information) of the quick response code by decoding software for the quick response code. The decoded image file may include information of the name of the lighting device, the name of the manufacturer, and the download address of the controlling and driving program corresponding to the lighting device. The download address may be the World Wide Web address and the file transfer protocol address.

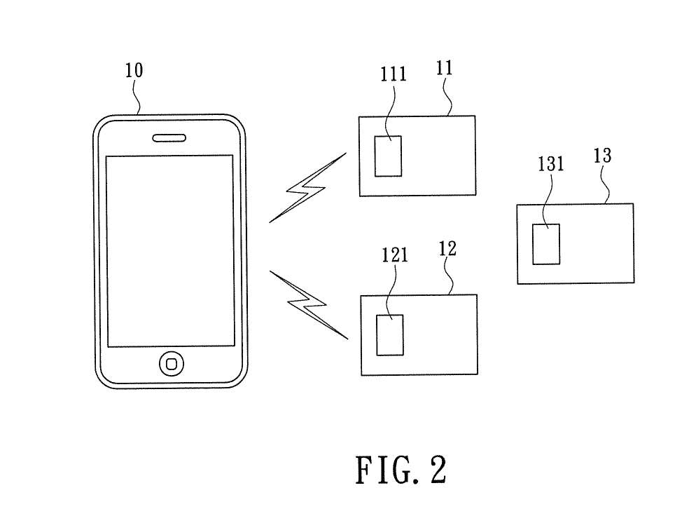

As such, the calculating device with internet capability connects to the internet for downloading the controlling and driving program according to the download address of the controlling and driving program. Generally speaking, for the controlling and driving program to be downloaded from the download address and to be installed thereafter the operation system of the calculating device with internet capability may have an internet browser and may be supportive of the function of installing the application programs. In conjunction with FIG. 1, please refer to FIG. 2 in which a schematic diagram of a link relation of lighting devices with quick response codes and a smart phone according to an embodiment of the present invention is disclosed. In this embodiment, the smart phone is an example of the calculating device with internet capability. In the step S13, the smart phone configures the internet protocol of the lighting device through the controlling and driving program. Because each of the lighting devices has a corresponding quick response code, when the smart phone configures the internet protocol of the lighting device the smart phone may also configure the internet protocol address of the lighting device according to the corresponding quick response of the lighting device. In other words, the smart phone may assign the internet protocol address of the lighting device according to the corresponding quick response code of the lighting device.

As shown in FIG. 2, the smart phone 10 links to the wireless transmission modules 111, 121, and 131 of the lighting devices 11 to 13. The specification (or standard) of linking may be wireless fidelity (WiFi). The smart phone 10 with the controlling and driving program may configure the control mode of the lighting devices 11 to 13 or may be capable of acknowledging real-time status of the lighting devices 11 to 13.

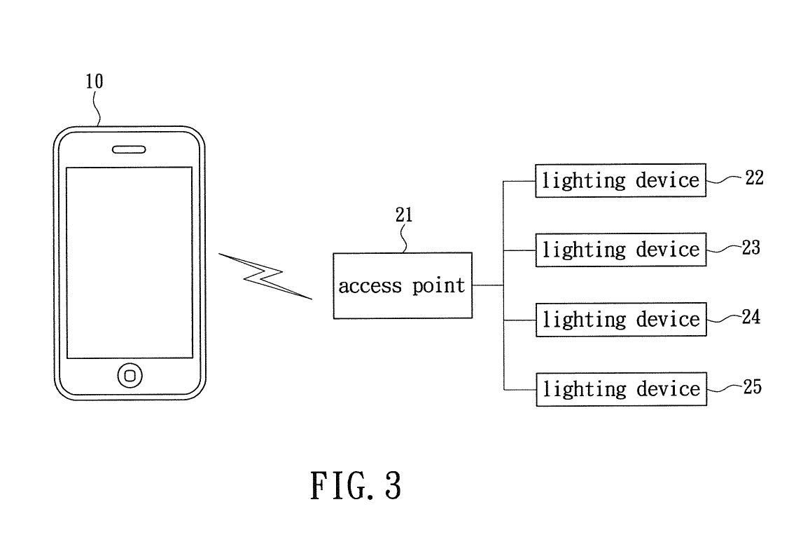

Please refer to FIGS. 1 and 3 with FIG. 3 showing a schematic diagram of a link relation of lighting devices with quick response codes and a smart phone according to an embodiment of the present invention. The smart phone links to an access point 21 firstly, which in turn links to the lighting devices 22 to 25. The access point 21 transmits a control signal of the smart phone 10 to the lighting devices 22 to 25, after the connection between the smart phone and the lighting device 22 to 25 has been established.

Linking the access point 21 and the lighting devices 22 to 25 may be accomplished by signal wires, but the present invention is not restricted thereto. The access point 21 may link to the lighting devices 22 to 25 wirelessly. In addition, the number of the lighting devices in this embodiment is for explanation, and the present invention is not so restricted. Besides, the access point 21 in one implementation may be another lighting device for bridging the lighting devices 22 to 25.

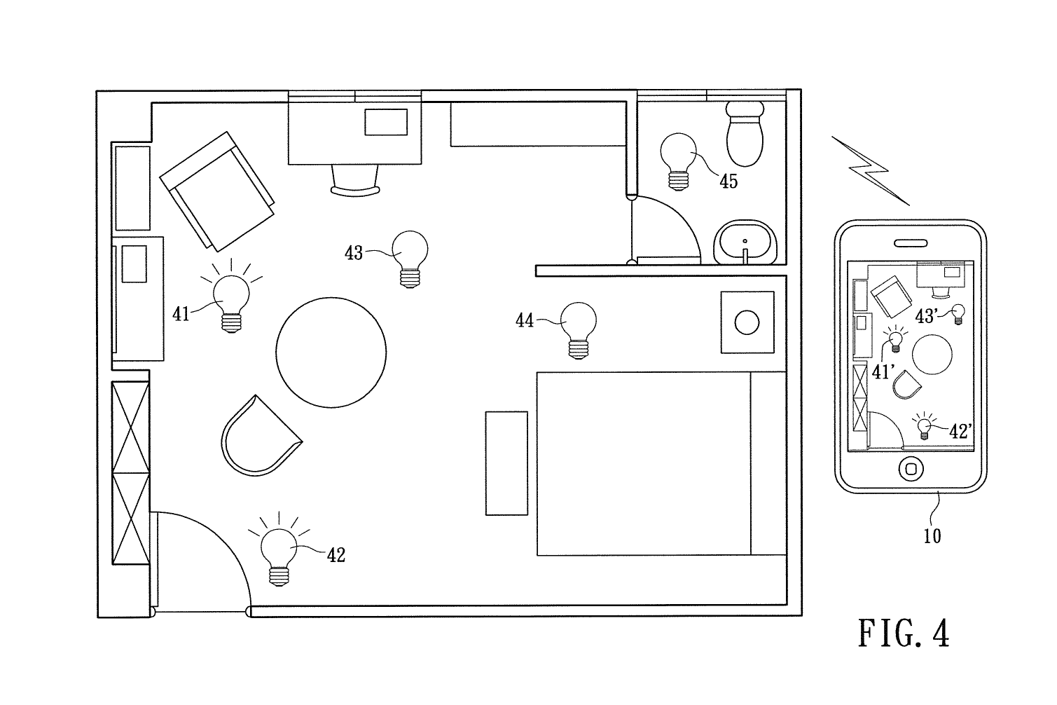

Please refer to FIG. 1 and FIG. 4. FIG. 4 shows a schematic diagram of the lighting devices with the quick response codes controlled by a smart phone according to an embodiment of the present invention. In the step S14, the smart phone may control the controlling and driving program to wirelessly control the lighting device through the internet protocol. Besides, contents of the smart phone controlling the lighting device may comprise turning-on/off the lighting device, adjusting the brightness of the lighting device, and setting the timing of the lighting device.

As shown in FIG. 4, the left part of FIG. 4 shows locations of the lighting devices 41 to 45 in a household, and the right part of FIG. 4 shows the smart phone 10 displaying icons 41′ to 43′ corresponding to the lighting devices 41 to 43. The operation interface of displaying the icons 41′ to 43′ may be integrated in the aforementioned program.

The lighting device to be controlled by the human operator may be selected by touching/clicking of the icons on the smart phone 10. For example, the user may select the icon 41′ and 42′ for turning on or turning off the lighting devices 41 and 42. The screen of the smart phone may display updated real-time status of the lighting devices 41 to 45 at the same time, and accordingly the status of the lighting devices 41 to 45 may become available on the smart phone 10.

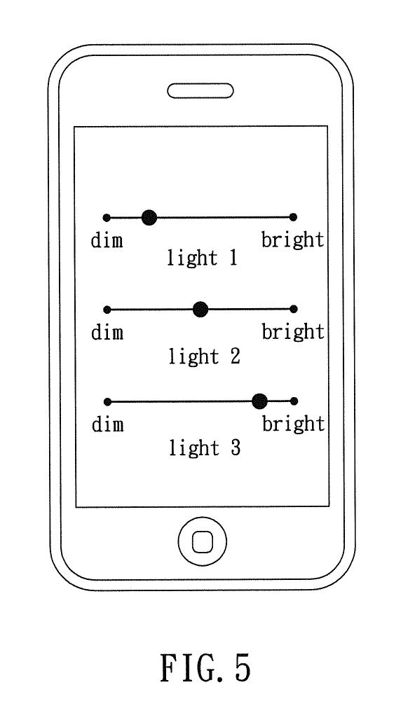

Please refer to FIG. 5, FIG. 5 shows a schematic diagram of an operation interface of a smart phone controlling the brightness of the lighting devices with the quick response codes according to an embodiment of the present invention. The human operator may also control the brightness of the lighting device by the operation interface shown in FIG. 5. The human operator may move a light adjusting icon along a sliding scale by pushing the button or touching the touch screen of the smart phone. For example, the icon for light 1 may be moved to the left for dimming the light, while another icon for light 2 is set in the middle of its respective sliding scale, and the icon for light 3 is moved close to rightmost end of the sliding scale for increasing the brightness of the corresponding light 3.

It is worth noting that other than turning on/off the lighting device and adjusting the brightness of the lighting device, the smart phone may also perform functions of timing setting, group control, or situational control. For example, the user may control a plurality of the lighting devices in certain predetermined situations. The situational control may, for example, include turning on the lighting device in the living room when turning on the lighting device at the entrance and dimming/turning off the lighting devices when the lighting device in the bedroom has been turned off.

It is worth noting that the electronic device in the steps S11 to S14 may be applied to the home appliance. Difference between home appliance and the lighting device may lie in control modes, which may vary among the home appliances of different types. For example, the control mode of the television set may include turning on/off, switching channels, or adjusting the volume of the television set. The control mode of the air conditioner, meanwhile, may include turning on/off and adjusting the temperature of the air conditioner. The control mode of the stereo set may include turning on/off, adjusting the volume, and timing setting.

It is also worth noting that linking mechanism between the home appliance and the smart phone may be the same as the lighting devices and the smart phone shown in FIG. 2 or FIG. 3. The home appliance may link to the smart phone by a wireless transmission module thereof, and the home appliance may be controlled by the smart phone once after the communication between the home appliance and the smart phone has been established accordingly. The home appliance may be controlled by the smart phone through the access point also.

According to these embodiments, the a method for wirelessly controlling electronic device with a quick response code and electronic device product using the same utilizes the calculating device with internet capability to capture the quick response code of the electronic device and to connect to the internet for downloading the control information corresponding to the electronic device provided by the manufacturer. The calculating device with internet capability can link to the electronic device wirelessly, or to an access point firstly, which in turn is connected to the electronic device by wires or wirelessly. The descriptions illustrated supra set forth simply the preferred embodiments of the present invention; however, the characteristics of the present invention are by no means restricted thereto. All changes, alternations, or modifications conveniently considered by those skilled in the art are deemed to be encompassed within the scope of the present invention delineated by the following claims.

What is claimed is:

1. A method for wirelessly controlling an electronic device with a quick response code, processing in a calculating device with internet capability, the method comprising:
receiving a graphics information of the quick response code of the electronic device, and decoding the quick response code;
downloading a controlling and driving program of the corresponding electronic device for installation according to the decoded quick response code;
configuring an internet protocol of the electronic device by the controlling and driving program; and
controlling the electronic device by the controlling and driving program through the internet protocol wirelessly.

2. The method according to claim 1, wherein the electronic device is a lighting device.

3. The method according to claim 2, wherein controlling the lighting device wirelessly comprises turning-on/off, adjusting a brightness of the lighting device, and setting a timing of the lighting device.

4. The method according to claim 1, wherein the electronic device is a home appliance.

5. The method according to claim 1, wherein configuring the internet protocol of the electronic device further comprises configuring the internet protocol of the electronic device according to the quick response code of the electronic device.

6. The method according to claim 1, wherein controlling the electronic device wirelessly further comprises transmitting a control signal of the calculating device with internet capability to the electronic device through an access point.

7. The method according to claim 1, wherein controlling the electronic device wirelessly further comprises transmitting a control signal of the calculating device with internet capability to a wireless transmission module of the electronic device

8. An electronic device product, comprising:
a quick response code for providing a download address of a controlling and driving program of an electronic device, wherein the quick response code is captured by an image capturing unit of a calculating device with internet capability, and the quick response code is decoded allowing for the calculating device with internet capability to retrieve the controlling and driving program of the electronic device from the download address before having the controlling and driving program of the electronic device installed therein, for facilitating a wireless control over the electronic device by the calculating device with internet capability on basis of a control signal; and
the electronic device, used for receiving the control signal of the calculating device with internet capability.

9. The electronic device product according to claim 8, wherein the calculating device with internet capability configures an internet protocol of the electronic device through the controlling and driving program according to the quick response code of the electronic device product.

10. The electronic device product according to claim 8, wherein the control signal of the calculating device with internet capability is transmitted to a wireless transmission module of the electronic device by an access point.

11. The electronic device product according to claim 8, wherein the electronic device is a lighting device or a home appliance.

12. The electronic device product according to claim 8, wherein the quick response code is printed on or adhered to a package, a user manual, or the electronic device.
